(19) United States
(12) Patent Application Publication
(10) Pub. No.: US 2025/0289364 A1
(43) Pub. Date: Sep. 18, 2025

(54) SPEED CONTROL APPARATUS, SPEED CONTROL METHOD AND NON-TRANSITORY COMPUTER READABLE MEDIUM

(71) Applicant: JVCKENWOOD Corporation, Yokohama-shi (JP)

(72) Inventors: Fumio TSUKAMOTO, Yokohama-shi (JP); Hirohiko YASUE, Yokohama-shi (JP); Takayuki SATO, Yokohama-shi (JP); Yusuke YAMAGUCHI, Yokohama-shi (JP)

(21) Appl. No.: 19/224,522

(22) Filed: May 30, 2025

Related U.S. Application Data
(62) Division of application No. 17/838,044, filed on Jun. 10, 2022.

(30) Foreign Application Priority Data
Jun. 11, 2021 (JP) 2021-097927

(51) Int. Cl. B60Q 1/50; B60K 31/00; G06F 3/14; G06Q 30/0251; G06V 40/10; G09F 9/30; G09F 21/00

(52) U.S. Cl. CPC B60Q 1/5037; B60K 31/00; G06F 3/14; G06Q 30/0265; G06V 40/10; G09F 9/30; G09F 21/00

(57) ABSTRACT

A display control apparatus, a speed control apparatus and a display control method capable of improving visibility of an advertisement in accordance with a situation are provided. The display control apparatus according to embodiments includes a speed information acquisition unit configured to acquire speed information of a mobile object provided with an advertisement display unit, and a display control unit configured to execute processing of changing a degree of change of an image of an advertisement to be displayed at the advertisement display unit based on the speed information.

### CROSS REFERENCE TO RELATED APPLICATION

This application is a Divisional of U.S. patent application Ser. No. 17/838,044, filed on Jun. 10, 2022, which is based upon and claims the benefit of priority from Japanese patent application No. 2021-097927, filed on Jun. 11, 2021, the disclosure of which is incorporated herein in its entirety by reference.

### BACKGROUND

The present disclosure relates to a display control apparatus, a speed control apparatus and a display control method.

A number of apparatuses such as signage terminals that display advertisements exist across the city. Various schemes have been devised as methods for displaying advertisements.

For example, Japanese Unexamined Patent Application Publication No. 2002-063482 discloses a system in which advertisement data transmission means wirelessly transmits computerized advertisement data to a vehicle, a receiver provided in the vehicle receives the advertisement data, and an advertisement display apparatus provided on the vehicle displays the received advertisement data. According to this configuration, the system causes advertisements to be displayed to persons outside the vehicle.

Further, Japanese Unexamined Patent Application Publication No. 2007-034585 discloses a system that causes advertisements to be displayed on a display monitor on a passage of an underground mall, an arcade, or the like, based on information on persons on the passage. Further, Japanese Examined Patent Application Publication No. H07-080435 discloses an information display apparatus that causes display data for advertisement to be displayed on a display of an automobile when speed of the automobile is zero and puts the display into a non-displayed state when the speed is not zero.

### SUMMARY

A display control apparatus according to the present embodiment includes a speed information acquisition unit configured to acquire speed information of a mobile object provided with an advertisement display unit, and a display control unit configured to execute processing of changing a degree of change of an image of an advertisement to be displayed at the advertisement display unit based on the speed information.

A speed control apparatus according to the present embodiment includes an advertisement information acquisition unit configured to acquire advertisement information to be displayed at an advertisement display unit provided on a mobile object, and a control unit configured to control speed of the mobile object based on the advertisement information.

A display control method according to the present embodiment includes a speed information acquisition step of acquiring speed information of a mobile object provided with an advertisement display unit, and a display control step of executing processing of changing a degree of change of an image of an advertisement to be displayed at the advertisement display unit based on the speed information.

### BRIEF DESCRIPTION OF THE DRAWINGS

The above and other aspects, advantages and features will be more apparent from the following description of certain embodiments taken in conjunction with the accompanying drawings, in which:

FIG. 1A is a block diagram illustrating a configuration example of a display system according to a first embodiment;

FIG. 1B is a block diagram illustrating a configuration example of an imaging apparatus according to the first embodiment;

FIG. 1C is a block diagram illustrating a configuration example of an advertisement display apparatus according to the first embodiment;

FIG. 1D is a block diagram illustrating a configuration example of a control unit according to the first embodiment;

FIG. 2 is a table indicating an example of advertisement information stored in a DB according to the first embodiment;

FIG. 3A is a flowchart illustrating an example of processing of a display control apparatus according to the first embodiment;

FIG. 3B is a flowchart illustrating an example of processing of the display control apparatus according to the first embodiment;

FIG. 4 is a table indicating an example of target speed corresponding to degrees of motion of an advertisement, stored in the DB according to the first embodiment;

FIG. 5 is a flowchart illustrating an example of processing of the display control apparatus according to the first embodiment;

FIG. 6 is a table indicating an example of target speed corresponding to advertisement display periods, stored in the DB according to the first embodiment;

FIG. 7 is a table indicating an example of target speed corresponding to advertisement display forms, stored in the DB according to the first embodiment;

FIG. 8A is a schematic view illustrating an example of the advertisement display form according to the first embodiment;

FIG. 8B is a schematic view illustrating another example of the advertisement display form according to the first embodiment;

FIG. 9 is a flowchart illustrating an example of processing of the display control apparatus according to the first embodiment;

FIG. 10A is a schematic view illustrating still another example of the advertisement display form according to the first embodiment;

FIG. 10B is a schematic view illustrating yet another example of the advertisement display form according to the first embodiment;

FIG. 11 is a flowchart illustrating an example of processing of the display control apparatus according to the first embodiment;

FIG. 12A is a block diagram illustrating a configuration example of a speed control system according to a second embodiment;

FIG. 12B is a block diagram illustrating a configuration example of an advertisement display apparatus according to the second embodiment;

FIG. 12C is a block diagram illustrating a configuration example of a control unit according to the second embodiment;

FIG. 13A is a table indicating an example of target speed corresponding to advertisement display periods, stored in a DB according to the second embodiment;

FIG. 13B is a table indicating an example of target speed corresponding to advertisement display forms, stored in the DB according to the second embodiment; and

FIG. 14 is a flowchart illustrating an example of processing of a speed control apparatus according to the second embodiment.

### DETAILED DESCRIPTION

### First Embodiment

A first embodiment of the present disclosure will be described below with reference to the drawings. In the first embodiment, a control example of an advertisement display apparatus mounted on a vehicle exterior (for example, a side surface portion or a rear surface of a vehicle body) of an automobile will be described. In a case where a display control method of the present disclosure is executed as a program, a computer in a display control apparatus of a display system executes the program. Further, hereinafter, an automobile (advertising car) on which the display system is mounted will be referred to as a vehicle.

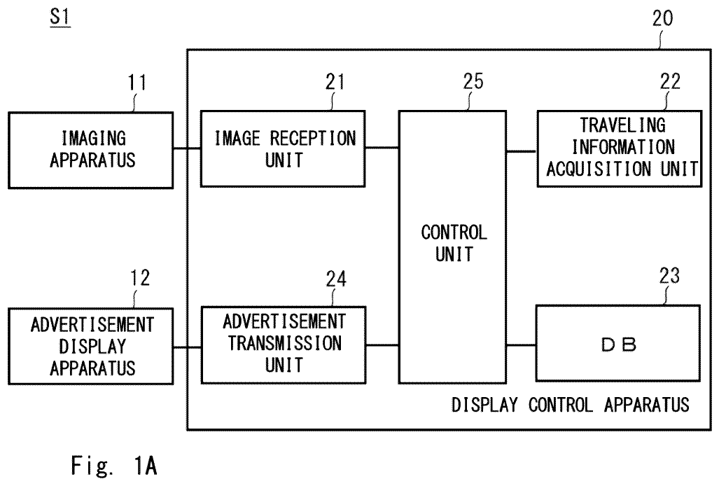

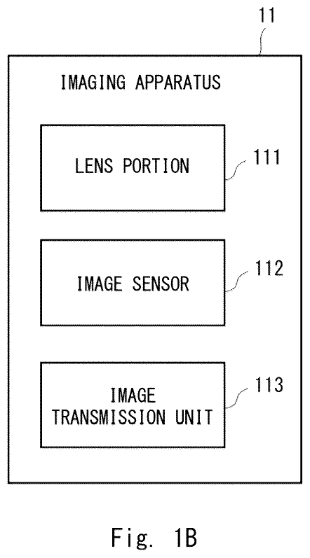

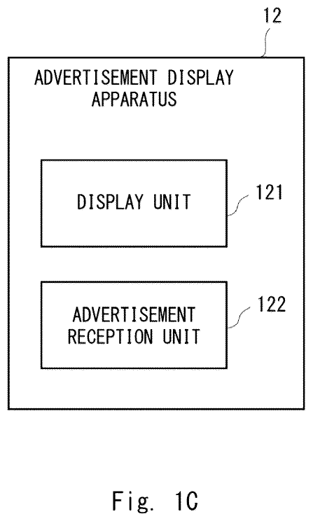

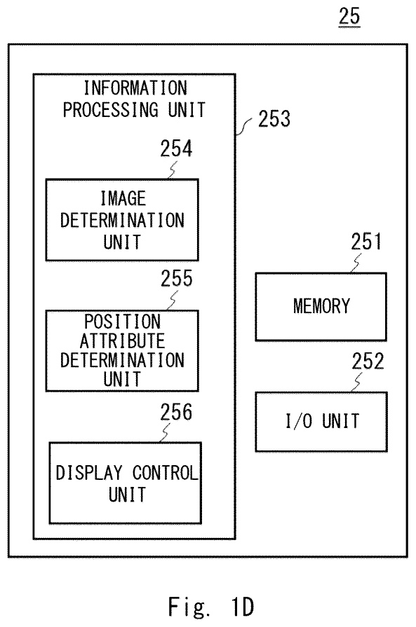

FIG. 1A is a block diagram illustrating a schematic configuration example of a display system S1. The display system S1 includes an imaging apparatus 11, an advertisement display apparatus 12 and a display control apparatus 20. Components of the display system S1 will be described below.

The imaging apparatus 11 is one or more cameras that generate image data by imaging outside of the vehicle. The imaging apparatus 11 is preferably mounted on the vehicle body at such a position and an angle that enables detailed information of a person who visually confirms the advertisement display apparatus 12 to be imaged. The imaging apparatus 11 may be, for example, a camera of visible light, but the imaging apparatus 11 is not limited to this example.

FIG. 1B is a block diagram illustrating a configuration example of the imaging apparatus 11. As illustrated in FIG. 1B, the imaging apparatus 11 includes a lens portion 111, an image sensor 112 and an image transmission unit 113. The lens portion 111 is an optical element related to imaging, and the image sensor 112 converts a captured image into an electrical signal. The image transmission unit 113 transmits the image signal converted at the image sensor 112 to the display control apparatus 20. Note that while in this example, the image data captured by the imaging apparatus 11 is a moving image, an image (still image) may be captured as the image data.

The advertisement display apparatus 12 is a digital signage capable of switching an advertisement to be displayed by control by the display control apparatus 20. As will be described later, an advertisement to be displayed at the advertisement display apparatus 12 is changed in accordance with information on a person who visually confirms the vehicle, and a situation regarding the vehicle such as position information of the vehicle and traveling information of the vehicle.

FIG. 1C is a block diagram illustrating a configuration example of the advertisement display apparatus 12. As illustrated in FIG. 1C, the advertisement display apparatus 12 includes a display unit 121 and an advertisement reception unit 122. The display unit 121 is a medium that displays advertisement data received by the advertisement reception unit 122 so as to be able to be visually confirmed by a person and, here, includes a display. As will be described later, an advertisement of one of a moving image, a plurality of still images and one still image is displayed by the display unit 121. The advertisement reception unit 122 receives the advertisement data from the display control apparatus 20.

Description will be continued returning to FIG. 1A. The display control apparatus 20 selects an advertisement to be displayed at the advertisement display apparatus 12 by acquiring information (traveling information) regarding traveling of the vehicle in addition to acquiring the image data from the imaging apparatus 11 and outputs the selected advertisement data to the advertisement display apparatus 12. The display control apparatus 20 includes an image reception unit 21, a traveling information acquisition unit 22, a database (DB) 23, an advertisement transmission unit 24 and a control unit 25. The respective units will be described in detail below.

The image reception unit 21 is a hardware interface that receives the image signal transmitted from the image transmission unit 113 of the imaging apparatus 11. The image reception unit 21 outputs the received image signal to the control unit 25.

The traveling information acquisition unit 22 acquires position information and speed information of the vehicle as the traveling information of the vehicle. This position information may include future position information (scheduled traveling route) in addition to current position information. The traveling information acquisition unit 22 may acquire the traveling information from, for example, a speed sensor provided in the vehicle or a car navigation system related to the position information of the vehicle or may acquire the traveling information by being connected to the Internet. However, information regarding traveling that can be acquired by the traveling information acquisition unit 22 is not limited to these.

The DB 23 is a DB that stores advertisement data that can be displayed by the advertisement display apparatus 12. Specifically, the DB 23 is a recording medium such as a flash memory, a memory card and a hard disk drive (HDD). Further, the DB 23 may be provided outside the advertisement display apparatus 12, in which case, the advertisement display apparatus 12 may acquire data stored in the DB 23 by connecting to the DB 23 via an information transmission/reception unit (not illustrated). In the DB 23, characteristic information of the advertisement is stored in association with the advertisement data. While in this example, the characteristic information includes a position attribute and a person attribute targeted by the advertisement, a degree of motion of the advertisement, and priority of advertisement display (hereinafter, simply referred to as priority), the characteristic information is not limited to these. Specific examples of the characteristic information stored in the DB 23 will be described later.

Further, in the DB 23, map information necessary for determining a type of a location at which the vehicle is located (that is, a position attribute) is stored. In this example, types of areas (such as a business district, a residential area, a downtown area and an academic district) and information indicating a specific area are indicated in the map information. The specific area may be, for example, an area where all or specific advertisements are allowed or restricted. Alternatively, the specific area may be a linear area along a route of a specific bus or railroad or a national road.

Further, in the DB 23, information necessary for determining whether or not an object in the image is a person and information necessary for determining an attribute of a person (person attribute) in image determination which will be described later are stored as information for determination. The person attribute is an attribute such as a person of a predetermined age or older (for example, an adult) and a person of a predetermined age or younger (for example, a minor), or an attribute based on gender, a type of a job, or the like, in this example. The information for determination includes information for determining characteristics of a person himself/herself such as gender, body height, age, constitution of the person and information for determining clothes, accessories, or the like, on the person for determining the person attribute.

Further, in the DB 23, advertisement information that the display control unit 256 controls the advertisement display apparatus 12 to display and information on display time of the advertisement information are stored as a log. This log is updated every time the display control unit 256 newly determines advertisement data to be displayed. Further, in the DB 23, various kinds of thresholds, and the like, to be used for determination processing which will be described later are stored.

The advertisement transmission unit 24 is a hardware interface that transmits the advertisement data selected by the control unit 25. The advertisement transmission unit 24 outputs the received advertisement data to the advertisement display apparatus 12.

The control unit 25 selects an appropriate advertisement from the DB 23 using the image signal received by the image reception unit 21 and the traveling information acquired by the traveling information acquisition unit 22 and outputs the advertisement data to the advertisement display apparatus 12 via the advertisement transmission unit 24.

FIG. 1D is a block diagram of the control unit 25. The control unit 25 includes a memory 251, an input/output (I/O) unit 252 and an information processing unit 253.

The memory 251 is constituted with a volatile memory, a non-volatile memory or a combination thereof. The number of the memories 251 is not limited to one, and a plurality of memories 251 may be provided. Note that the volatile memory may be, for example, a random access memory (RAM) such as a dynamic random access memory (DRAM) and a static random access memory (SRAM). The non-volatile memory may be, for example, a programmable ROM (PROM), an erasable programmable read only memory (EPROM) or a flash memory.

The memory 251 is used for storing one or more commands. Here, one or more commands are stored in the memory 251 as software modules. The information processing unit 253 can perform the following processing by reading out one or more commands from the memory 251 and executing the commands.

The I/O unit 252 is a hardware interface that executes input/output of information to/from outside of the control unit 25. In this embodiment, the control unit 25 is connected to the image reception unit 21, the traveling information acquisition unit 22, the DB 23 and the advertisement transmission unit 24 and inputs/outputs information to/from these units via the I/O unit 252.

The information processing unit 253 is constituted with arbitrary processors, and the like, such as a central processing unit (CPU), a micro processing unit (MPU), a field-programmable gate array (FPGA), a digital signal processor (DSP) and an application specific integrated circuit (ASIC). Note that the memory 251 may include a memory incorporated into the information processing unit 253 as well as a memory provided outside the information processing unit 253.

The information processing unit 253 implements functions of an image determination unit 254, a position attribute determination unit 255, a display control unit 256, and the like, by reading out software (computer program) from the memory 251 and executing the software. These functions will be described below.

The image determination unit 254 derives information on persons in the image that is captured by the imaging apparatus 11 and received by the image reception unit 21, using the information for determination stored in the DB 23 described above. The derived person information includes information such as the number of the persons in the image, locations where the persons are located, and person attributes of the persons. A publicly known technique can be used as appropriate as the method for determining the persons.

The position attribute determination unit 255 derives a position attribute of a current position of the vehicle using the position information of the vehicle acquired by the traveling information acquisition unit 22 and the map information stored in the DB 23 described above. In detail, the position attribute determination unit 255 derives the information on the position attribute by specifying the position information of the vehicle in the map information and specifying a position attribute of the position.

The display control unit 256 selects appropriate advertisement data from the advertisement data stored in the DB 23 using at least one of the speed information of the vehicle acquired by the traveling information acquisition unit 22, the person information in the image derived by the image determination unit 254 or the position attribute of the current position of the vehicle derived by the position attribute determination unit 255 and causes the advertisement data to be displayed at the advertisement display apparatus 12. The specific processing will be described later. Further, the display control unit 256 stores the advertisement information determined to be displayed at the advertisement display apparatus 12 and display time of the advertisement information in the DB 23 as a log.

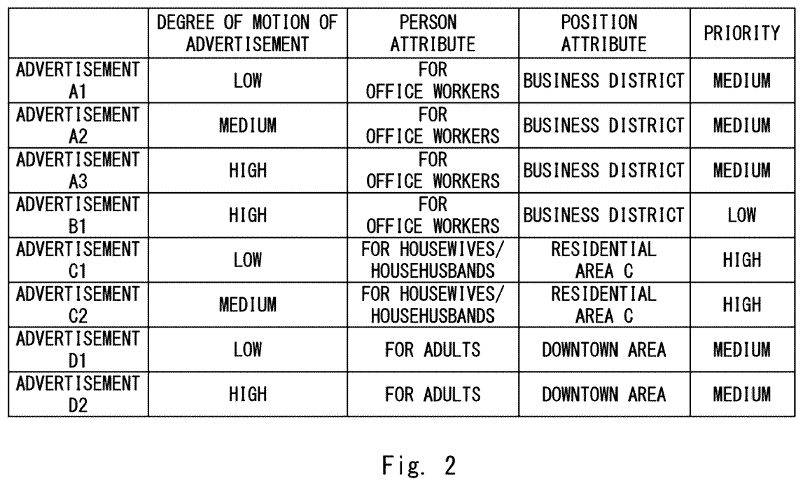

FIG. 2 is a table indicating an example of advertisement information of advertisement data that can be displayed, stored in the DB 23. FIG. 2 indicates advertisements A1 to A3, B1, C1, C2, D1 and D2 as labels indicating advertisements and indicates degrees of motion of the advertisements, targeted person attributes, position attributes and priority as the characteristic information. Here, the advertisements A1 to A3 are advertisements regarding the same office supplies A, and the advertisement B1 is an advertisement regarding company B. Further, both the advertisements C1 and C2 are advertisements regarding stores (for example, including at least one of a supermarket, a shopping center, a pharmacy or a restaurant) located near a residential area C in a specific area, and the advertisements D1 and D2 are advertisements regarding the same alcohol D.

Further, the respective pieces of the characteristic information are as follows. The “degree of motion of the advertisement” is a period or a ratio of a still image being displayed in each advertisement, and three stages of “low”, “medium” and “high” are set in FIG. 2. The degree of motion of the advertisement becomes higher in order of “low”, “medium” and “high”. In this example, “low” of the “degree of motion of the advertisement” indicates a case where the advertisement is one still image and there is no motion in advertisement display. “Medium” of the “degree of motion of the advertisement” indicates a case where the advertisement includes a plurality of still images and a still image is switched to another still image for each of one to several seconds. “High” of the “degree of motion of the advertisement” indicates a case where the advertisement is constituted with a moving image and the advertisement is always in motion.

Further, the “person attribute” of the characteristic information indicates attribute of persons targeted by the advertisement. In FIG. 2, three types of advertisements “for office workers”, “for housewives/househusbands” and “for adults” are set. The advertisements “for office workers” and “for housewives/househusbands” are targeted for persons in a predetermined age group, and particularly, the advertisements “for office workers” are targeted for persons who wear clothes for business office such as suits. Further, the advertisements “for adults” are targeted for adults and relate to products, or the like, for which it is preferable to restrict advertisement to minors.

Further, the “position attribute” of the characteristic information indicates characteristics of an area for which the advertisement is targeted, and in FIG. 2, three types of an “office district”, a “residential area C”, a “downtown area” are set. The “office district”, the “residential area” and the “downtown area” respectively refer to an office building, a residential district and an area with a number of commercial facilities and restaurants, and the “residential area C” indicates a residential area in a specific area as described above.

Further, the “priority” of the characteristic information is set to indicate which advertisement is to be preferentially displayed in a case where a plurality of advertisements are selected as advertisements to be displayed as will be described later. In FIG. 2, three stages of “low”, “medium” and “high” are set, and priority is higher for “medium” than “low”, and priority is higher for “high” than “low” and “medium”.

The advertisements Al to A3 have the person attribute of “for office workers”, have the position attribute of the “office district” and have the priority of “medium” in common. However, the “degrees of motion of the advertisements” of the advertisements A1, A2 and A3 are respectively “low”, “medium” and “high”, which are different from one another. The advertisement B1 has the “degree of motion of the advertisement” of “high”, has the person attribute of “for office workers”, have the position attribute of the “office district” and has the priority of “low”. The advertisements C1 and C2 have the person attributes of “for housewives/househusbands”, have the position attribute of the “residential area C” and have the priority of “high” in common. However, the “degrees of motion of the advertisements” of the advertisements C1 and C2 are respectively “low” and “medium”, which are different from each other.

As the characteristic information described above, characteristic information generated by an apparatus located outside the display control apparatus 20 may be stored in the DB 23, or results determined by analyzing the advertisement data by the control unit 25 may be stored in the DB 23. Some examples of processing of selecting an advertisement to be executed by the display control unit 256 will be described below using examples of information illustrated in FIG. 2.

### (1A)

First, an example where the display control unit 256 selects appropriate advertisement data from the advertisement data stored in the DB 23 using the position information of the vehicle and the person information and causes the advertisement data to be displayed at the advertisement display apparatus 12 will be described.

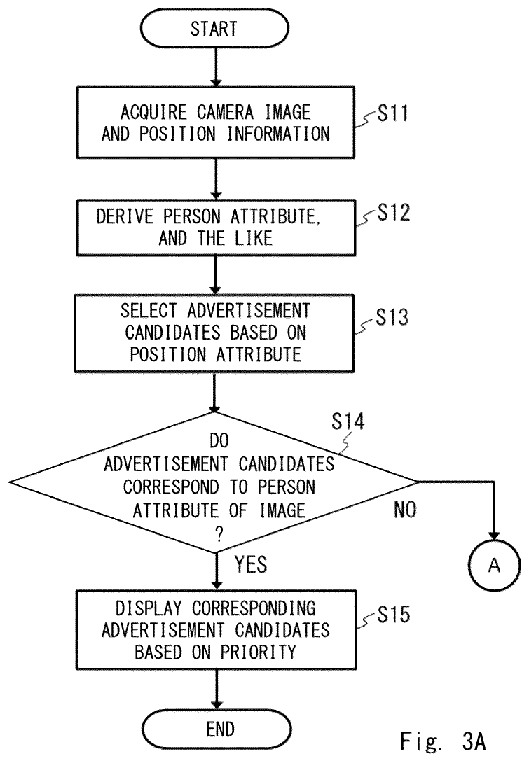

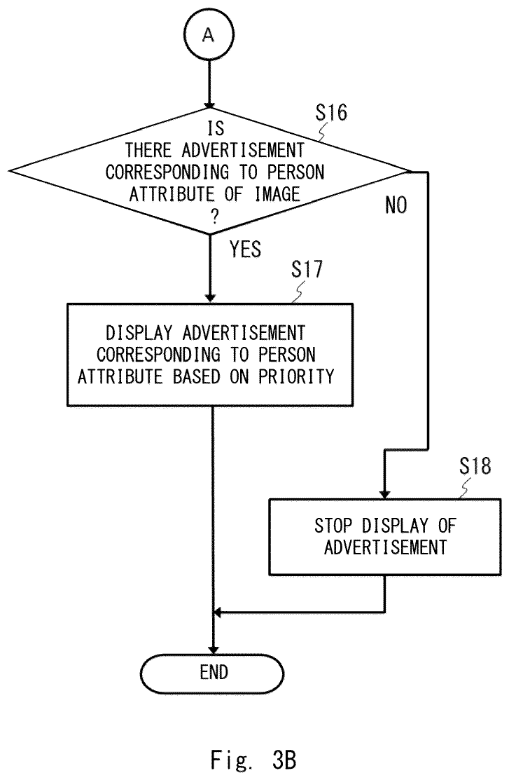

FIGS. 3A and 3B are flowcharts illustrating an example of processing to be executed by the display control apparatus 20, and the processing of the display control apparatus 20 will be described below with reference to FIGS. 3A and 3B. First, the image reception unit 21 acquires image data from the imaging apparatus 11, and the traveling information acquisition unit 22 acquires position information as part of traveling information (step S11).

The image determination unit 254 derives person information (particularly, a person attribute) in the image using the information for determination (step S12). In a case where there is one person in the image, the image determination unit 254 derives a person attribute of the person as the person attribute in the image. Further, in a case where there are a plurality of persons in the image, and in a case where it is determined that the persons in the image include minors equal to or more than a predetermined number or equal to or higher than a predetermined ratio, the image determination unit 254 derives a “minor” as the person attribute of the image. Note that a threshold regarding the predetermined number or the predetermined ratio to be used for deriving the “minor” as the person attribute is stored in the DB 23, and the image determination unit 254 executes determination using the threshold. In this example, the threshold is “one person”, and the image determination unit 254 derives the “minor” as the person attribute in the image in a case where it is determined that the persons in the image include one or more minors. Further, in a case where the “minor” is not derived as the person attribute in the image, the image determination unit 254 derives an attribute common to most persons among a plurality of persons as the person attribute in the image. In this manner, the image determination unit 254 functions as a person attribute determination unit that determines an attribute of persons.

The position attribute determination unit 255 derives a position attribute of a current position of the vehicle based on the position information of the vehicle acquired by the traveling information acquisition unit 22. The display control unit 256 selects advertisements having a position attribute that matches the position attribute derived by the position attribute determination unit 255 as the characteristic information, as advertisement candidates from the advertisement data stored in the DB 23 (step S13).

The display control unit 256 determines whether or not there is an advertisement candidate corresponding to the person attribute of the image derived by the image determination unit 254 (that is, an advertisement candidate having a person attribute that matches the person attribute of the image) among the advertisement candidates selected in step S13 (step S14). In a case where there is an advertisement candidate having a person attribute that matches the person attribute of the image in step S14, it can be said that the area is an optimal area for displaying the advertisement candidate, and there is a person optimal for displaying the advertisement candidate.

In a case where there is an advertisement candidate corresponding to the person attribute of the image derived by the image determination unit 254 among the selected advertisement candidates (step S14: Yes), the display control unit 256 performs control to cause the corresponding advertisement candidate to be displayed based on the priority of the advertisement candidate (step S15). Specifically, the display control unit 256 transmits advertisement data of the advertisement candidate to the advertisement display apparatus 12 via the advertisement transmission unit 24. The advertisement display apparatus 12 displays the advertisement data.

In a case where there is only one corresponding advertisement candidate, the display control unit 256 causes the one advertisement candidate to be displayed. In a case where there are a plurality of corresponding advertisement candidates, and priority of the respective advertisement candidates is different, the display control unit 256 causes an advertisement candidate having higher priority to be preferentially displayed. The display control unit 256 can use, for example, one of the following methods as the method for preferentially displaying an advertisement candidate.
cause only an advertisement candidate with the highest priority to be displayed
cause an advertisement candidate with higher priority to be displayed for a longer period than a period for displaying an advertisement candidate with lower priority within a predetermined period
cause an advertisement candidate with higher priority to be displayed more times than the number of times of display of an advertisement candidate with lower priority within a predetermined period
make a display area of an advertisement candidate with higher priority larger than a display area of an advertisement candidate with lower priority in a case where the advertisement candidate with higher priority and the advertisement candidate with lower priority are displayed at the same time at the display unit 121 (display)

Note that in a case where a plurality of advertisement candidates have the same priority, the display control unit 256 controls advertisement display as follows. If the plurality of advertisement candidates include advertisements of different targets (such as a product, a service and a company), the display control unit 256 causes the advertisement candidates of the respective targets to be equally displayed. For example, the display control unit 256 may cause the advertisement candidates of different targets to be respectively displayed for the same period or the same number of times within a predetermined period or may make display areas of the respective advertisement targets the same.

Further, in a case where a plurality of advertisement candidates are advertisements of the same target and have different “degrees of motion of advertisements”, the display control unit 256 may cause these advertisement candidates to be displayed equally regarding display frequencies and display regions. Alternatively, the display control unit 256 may select one advertisement candidate from these advertisement candidates in accordance with the situation and may cause the selected advertisement candidate to be displayed. The selection method will be described later in (1B).

Description will be continued returning to FIG. 3A. In the determination in step S14, in a case where there is no advertisement candidate corresponding to the person attribute of the image derived by the image determination unit 254 among the selected advertisement candidates (step S14: No), the display control unit 256 executes the following processing. The display control unit 256 determines whether or not there is advertisement data corresponding to the person attribute of the image (that is, an advertisement candidate having a person attribute that matches the person attribute of the image) among the advertisement data stored in the DB 23 as well as the advertisement candidates selected once (step S16). In a case where an advertisement having a person attribute that matches the person attribute of the image is stored in the DB 23 in step S16, it can be said that the situation is a situation where there is a person optimal for displaying the advertisement candidate.

In a case where there is advertisement data corresponding to the person attribute of the image derived by the image determination unit 254 among the advertisement data stored in the DB 23 (step S16: Yes), the display control unit 256 performs control to cause the corresponding advertisement data to be displayed based on the priority of the advertisement data (step S17). A display method based on priority is similar to that in step S15, and thus, description will be omitted. It can be said that the advertisement displayed in step S17 is suitable for a situation in which the vehicle is located, although not as suitable as the advertisement displayed in step S15.

In a case where there is no advertisement data corresponding to the person attribute of the image derived by the image determination unit 254 among the advertisement data stored in the DB 23 (step S16: No), the display control unit 256 performs control to stop display of an advertisement by not transmitting the advertisement data to the advertisement display apparatus 12 (step S18).

Note that the display control unit 256 stores the advertisement information determined to be displayed in step S15 or S17 and a display period of the advertisement information in the DB 23 as a log. Further, in a case where a period during which an advertisement is not displayed occurs as a result of the processing in step S18, the display control unit 256 also stores the period during which an advertisement is not displayed in the DB 23 as a log.

A specific example of the processing illustrated in FIGS. 3A and 3B will be further described using the example in FIG. 2.

As a first example, if the person attribute derived in step S12 is an “office worker”, and the position attribute derived in step S13 is a “business district”, the display control unit 256 selects the advertisements Al to A3 and the advertisement B1 as advertisement candidates in step S13. Then, the display control unit 256 determines that a person attribute of the advertisements A1 to A3 and the advertisement B1 that are the selected advertisement candidates is “for office workers” in step S14 and causes the advertisements A1 to A3 and the advertisement B1 to be displayed so that the advertisements A1 to A3 are displayed in preference to the advertisement B1 in step S15. Here, the display control unit 256 can select one or more advertisements to be displayed among the advertisements A1 to A3 and cause the selected advertisement regarding an item A to be displayed in preference to the advertisement B1.

As a second example, if the person attribute derived in step S12 is a “housewife/househusband”, and the position attribute derived in step S13 is a “residential area C”, the display control unit 256 selects the advertisements C1 and C2 as advertisement candidates in step S13. Then, the display control unit 256 determines that a person attribute of the advertisements C1 and C2 is “for housewives/househusbands” in step S14 and causes at least one of the advertisement C1 or C2 to be displayed in step S15.

As a third example, it is assumed that the person attribute derived in step S12 is an “office worker”, and the position attribute derived in step S13 is a “residential area C”. In this event, the display control unit 256 selects the advertisements C1 and C2 as advertisement candidates in step S13. The display control unit 256 determines that a person attribute of the advertisements C1 and C2 that are selected advertisement candidates is not “for office workers” in step S14 and determines whether or not there is advertisement data having a person attribute of “for office workers” among the advertisement data stored in the DB 23 in step S16. The display control unit 256 selects the advertisements A1 to A3 and the advertisement B1 in step S16 and causes the advertisements A1 to A3 and the advertisement B1 to be displayed so that the advertisements A1 to A3 are displayed in preference to the advertisement B1 in step S17.

As a fourth example, it is assumed that the person attribute derived in step S12 is an “adult”, and the position attribute derived in step S13 is a “downtown area”. In this event, the display control unit 256 selects advertisements D1 and D2 as advertisement candidates in step S13. The display control unit 256 determines in step S14 that a person attribute of the advertisements D1 and D2 that are the selected advertisement candidates is “for adults” and causes at least one of the advertisement D1 or D2 to be displayed in step S15.

In this case, the image data captured by the imaging apparatus 11 does not include a minor. However, in a case where the state changes from this state to a state where the image data captured by the imaging apparatus 11 includes a minor, the person attribute derived in step S12 can become the “minor”. Although the display control unit 256 selects the advertisements D1 and D2 as the advertisement candidates based on the position attribute in step S13, the display control unit 256 determines that the person attribute of the advertisements D1 and D2 that are the selected advertisement candidates is not “for minors” in step S14. Then, the display control unit 256 determines whether or not there is advertisement data having a person attribute of “for minors” among the advertisement data stored in the DB 23 in step S16. The display control unit 256 determines that there is no such an advertisement in step S16 and stops advertisement display in step S18.

In this manner, in a case where an advertisement for which it makes little sense to be viewed by minors, and an advertisement inappropriate to be viewed by minors are stored in the DB 23, the display control apparatus 20 can prevent such advertisements from being displayed at a location where there is a minor. Note that advertisement data having a person attribute of “for minors” (for example, advertisements of items, programs, and the like, for education and children) or advertisement data “for the public” (advertisements targeted for all people including minors) may be stored in the DB 23. In this case, in the fourth example, when the captured image data includes a minor, the display control unit 256 can determine that there is advertisement data having a person attribute of “for minors” or “for the public” in step S16 and can cause the advertisement to be displayed in step S17.

As described above, the display control apparatus 20 can select an advertisement in accordance with a situation based on person information on persons who are to view the advertisement and an environment in which the vehicle is located and can cause the advertisement to be displayed. Note that as a result of information such as a person attribute, a position attribute and priority being included as characteristic information of the advertisement, the display control apparatus 20 can easily select an advertisement more appropriately in accordance with the situation by comparing these kinds of information with the person attribute and the position attribute derived based on the image data and the traveling information.

Note that the above-described examples can be changed as appropriate. For example, in a case where the image determination unit 254 determines in step S12 that the image data does not include a person, the display control unit 256 may determine that there is no person who views an advertisement and may stop display of the advertisement. The display control apparatus 20 executes the processing of selecting an advertisement described above when the state changes to a state where the image data includes a person by executing the processing from step S11 based on a predetermined timing.

The display control unit 256 may select advertisement data corresponding to the person attribute of the image derived by the image determination unit 254 from the advertisement data stored in the DB 23 as the advertisement candidates in step S13. Then, the display control unit 256 determines whether or not there is an advertisement candidate having a position attribute that matches the position attribute derived by the position attribute determination unit 255 as the characteristic information among the selected advertisement candidates in step S14. If there is an advertisement candidate having a position attribute that matches the position attribute derived by the position attribute determination unit 255, the display control unit 256 causes the advertisement having the position attribute that matches the position attribute derived by the position attribute determination unit 255 to be displayed based on the priority. On the other hand, if there is no advertisement candidate having a position attribute that matches the position attribute derived by the position attribute determination unit 255, the display control unit 256 causes the selected advertisement candidates to be displayed based on the priority.

Further, the display control unit 256 may use information of only one of the position attribute and the person attribute acquired through the processing of the control unit 25 to select advertisement data having a position attribute or a person attribute that matches the information and may cause the selected advertisement data to be displayed based on the priority. Further, the priority of the advertisements is not essential and does not have to be set.

### (1B)

An example will be described next where the display control unit 256 selects appropriate advertisement data from the advertisement data stored in the DB 23 using the speed information of the vehicle and causes the advertisement data to be displayed at the advertisement display apparatus 12.

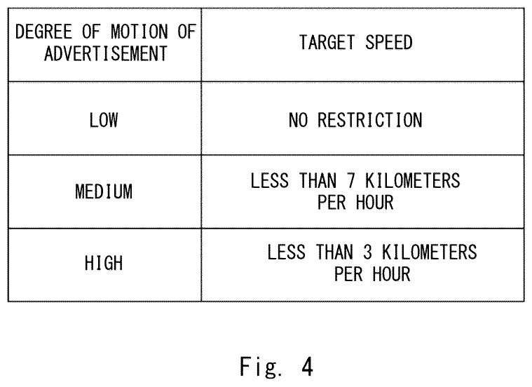

FIG. 4 is a table indicating an example of target speed corresponding to degrees of motion of the advertisements stored in the DB 23. The target speed indicates speed of the vehicle at which an advertisement with a specific degree of motion is to be displayed. FIG. 4 indicates that in a case where the degree of motion of the advertisement is “low”, there is no restriction on the target speed, in a case where the degree of motion of the advertisement is “medium”, the target speed is “less than 7 kilometers per hour”, and in a case where the degree of motion of the advertisement is “high”, the target speed is “less than 3 kilometers per hour”.

It is predicted that as the degree of motion is higher, appealing power of the advertisement to be displayed at the vehicle becomes higher, and the advertisement attracts more interest from people. However, as the speed of the vehicle is higher, a period during which a person can view the advertisement posted on the vehicle becomes shorter, and the person needs to move the line of sight more quickly to view the advertisement. In other words, as the speed of the vehicle is higher, it is difficult for a person to view the advertisement. It is therefore preferable to improve visibility of the advertisement to be displayed as the speed of the vehicle is higher. The visibility of the advertisement is improved as the degree of motion is lower. Thus, in the example related to FIG. 4, a threshold is set for the speed so that the visibility is improved by enabling an advertisement with a higher degree of motion to be displayed in a case where the speed of the vehicle is lower and lowering a degree of motion of an advertisement that can be displayed as the speed of the vehicle becomes higher.

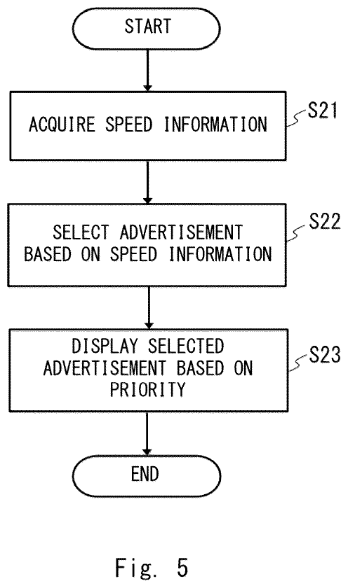

FIG. 5 is a flowchart illustrating an example of processing to be executed by the display control apparatus 20, and the processing of the display control apparatus 20 will be described below with reference to FIG. 5. First, the traveling information acquisition unit 22 acquires the speed information of the vehicle as part of the traveling information (step S21).

The display control unit 256 selects an advertisement to be displayed at the advertisement display apparatus 12 using the speed information acquired in step S21 and the table indicated in FIG. 4 (step S22). Then, the display control unit 256 causes the advertisement data selected in step S22 to be displayed at the advertisement display apparatus 12 based on the set priority (step S23).

A case will be assumed as an example where the advertisement data indicated in FIG. 2 is stored in the DB 23. In a case where the speed of the vehicle acquired in step S21 is 5 kilometers per hour, the display control unit 256 selects the advertisements A1, A2, C1, C2 and D1 in step S22.

Here, the display control unit 256 may select and display any one of the advertisements A1 and A2 of the same advertisement target. Also concerning the advertisements C1 and C2, the display control unit 256 may select and display any one of the advertisements C1 and C2. However, in both cases, in terms of improving appealing power of the advertisement, it is preferable to select and display an advertisement with a higher degree of motion of the advertisement. Thus, in this example, the display control unit 256 selects the advertisements A2 and C2.

The display control unit 256 causes the advertisements A2, C2 and D1 to be displayed at the advertisement display apparatus 12 based on the priority of the advertisements A2, C2 and D1 in step S23. In this case, the display control unit 256 causes the advertisement C2 to be displayed in preference to the advertisement A2 and D1. Further, the priority of the advertisements A2 and D1 is the same, and thus, the display control unit 256 causes the advertisements A2 and D1 to be equally displayed. The specific method has been described in (1A).

Note that in a case where the state changes from this display state to a state where the speed of the vehicle is increased to 10 kilometers per hour, the display control unit 256 selects the advertisements A1, C1 and D1 in step S22 and causes these advertisements to be displayed at the advertisement display apparatus 12 based on the priority in step S23. Thus, the advertisement C2 to be displayed is replaced with the advertisement C1 with higher visibility.

Further, in a case where the state changes from this display state to a state where the vehicle is stopped (that is, the speed becomes 0 kilometers per hour), the display control unit 256 selects all the advertisements in FIG. 2 in step S22. Thereafter, the display control unit 256 selects again an advertisement with the highest degree of motion for the advertisements of the same advertisement target. Thus, in step S23, the advertisements A3, B1, C2 and D2 with higher appealing power are displayed at the advertisement display apparatus 12 based on the priority.

As described above, the display control apparatus 20 can change a degree of change of an image of the advertisement to be displayed at the advertisement display apparatus 12 based on the speed information of the vehicle. By this means, the display control apparatus 20 can improve visibility of the advertisement in accordance with a situation. Note that in a case where the degree of change of the image is changed, the advertisements to be displayed may be advertisements of the same advertisement target as the advertisement target before the change, or may be advertisements of advertisement targets different from the advertisement target before the change.

Note that the above-described examples can be changed as appropriate. For example, the threshold of the speed indicated in FIG. 4 may be changed by an administrator. Alternatively, the threshold may be changed in accordance with a display period or the number of times an advertisement having a predetermined degree of motion is displayed at the advertisement display apparatus 12. For example, a threshold that makes a display period of an advertisement having a degree of motion of “high” within a predetermined period, equal to or greater than 25% of the predetermined period is set in the DB 23. Then, the display control unit 256 determines that the display period of the advertisement having the degree of motion of “high” within a certain predetermined period is only 15% of the predetermined period with reference to the log stored in the DB 23. In this event, the display control unit 256 determines that it is necessary to increase a display period for the advertisement with the degree of motion of “high” by comparing the threshold of the display period with an actual display period and increases a speed threshold for the degree of motion of “high” in FIG. 4. For example, the target speed for the degree of motion of “high” may be increased to “less than 5 kilometers per hour”.

Further, in a case where as a result of increasing the speed threshold for the degree of motion of “high” to achieve the above-described purpose, the speed threshold becomes the same value as a speed threshold for the degree of motion of “medium” or a difference between the speed thresholds is less than a predetermined threshold, the display control unit 256 may increase the speed threshold for the degree of motion of “medium”. In this manner, the display control unit 256 performs control so that the advertisement with the degree of motion of “high” is displayed for a longer period.

Similar processing can be executed for an advertisement with the degree of motion of “medium”. This can prevent an advertisement with lower appealing power to be displayed at the advertisement display apparatus 12 for a period longer than necessary.

Further, in the above-described example, in a case where the “degree of motion of the advertisement” is “low”, the advertisement is one still image, in a case where the “degree of motion of the advertisement” is “medium”, the advertisement includes a plurality of still images, and in a case where the “degree of motion of the advertisement” is “high” the advertisement is a moving image. However, definition of the “degree of motion of the advertisement” is not limited to such definition.

For example, concerning an advertisement of a moving image, a degree of motion of an advertisement of a moving image for which the number of times of switching of scenes per one advertisement or per predetermined period is less than a predetermined first threshold Th1 may be defined as “low”, a degree of motion of an advertisement of a moving image for which the number of times of switching of scenes is equal to or larger than a predetermined second threshold Th2 (Th2>Th1) may be defined as “high”, and degrees of motion of advertisements of other moving images may be defined as “medium”. In this case, a moving image with the degree of motion of the advertisement of “high” corresponds to an advertisement of, for example, an action movie, a game, or the like, and a moving image with the degree of motion of the advertisement of “medium” or “low” corresponds to an advertisement of a normal item, or the like.

As another example, concerning an advertisement of one still image, a degree of motion of an advertisement of a moving image for which the number of times of blinking on a screen per one advertisement or per predetermined period is less than a predetermined third threshold Th3 may be defined as “low”, a degree of motion of an advertisement of a moving image for which the number of times of blinking is equal to or larger than a predetermined fourth threshold Th4 (Th4>Th3) may be defined as “high”, and degrees of motion of advertisements of other moving images may be defined as “medium”. Note that similar settings can be made for an advertisement including a plurality of still images and an advertisement including a moving image as well as an advertisement of one still image.

In the above-described example, a degree of motion in an image of a certain one advertisement is defined as the “degree of motion of the advertisement”. However, the “degree of motion of the advertisement” may be defined as a frequency of switching of an advertisement from an advertisement of f a still image to an advertisement of another still image.

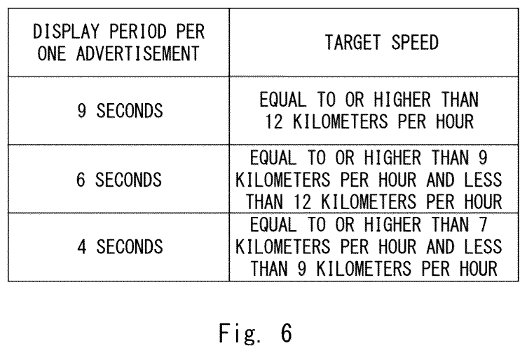

FIG. 6 is a table indicating an example of target speed corresponding to display periods per one image of an advertisement of a still image, stored in the DB 23. The target speed indicates speed of the vehicle at which an advertisement of one still image is displayed for each display period. FIG. 6 indicates that in a case where a display period of an advertisement of one still image is “9 seconds”, the target speed is “equal to or higher than 12 kilometers per hour”, in a case where the display period of the advertisement of one still image is “6 seconds”, the target speed is “equal to or higher than 9 kilometers per hour and less than 12 kilometers per hour”, and in a case where the display period of the advertisement of one still image is “4 seconds”, the target speed is “equal to or higher than 7 kilometers per hour and less than 9 kilometers per hour”. Note that in a case where the speed of the vehicle is less than 7 kilometers per hour, as indicated in FIG. 4, an advertisement with the degree of motion of equal to or higher than “medium” is displayed.

In a case where the speed of the vehicle is equal to or higher than 7 kilometers per hour, the display control unit 256 selects the advertisements A1, C1 and D1 among the advertisements stored in FIG. 2 and causes these advertisements to be displayed at the advertisement display apparatus 12 based on the priority. In this event, as indicated in FIG. 6, the display control unit 256 makes a display period of an advertisement of one still image longer as the speed of the vehicle is higher. In other words, the display control unit 256 lowers a frequency of switching of an advertisement of a still image to an advertisement of another still image. As described above, it is preferable to improve visibility of the advertisement to be displayed as the speed of the vehicle is higher. Thus, as indicated in FIG. 6, by changing a frequency of switching of advertisements in accordance with speed, it is possible to improve visibility of the advertisements in accordance with a situation.

Further, the processing in (1B) described above is combined with processing of all or arbitrary part of (1A). For example, in step S15 in FIG. 3A of (1A), in a case where the display control unit 256 selects the advertisements A1 to A3 and B1 in FIG. 2, the processing in step S21 and S22 in FIG. 5 may be executed at the display control apparatus 20. This enables the display control unit 256 to further specify an appropriate advertisement in accordance with the speed information of the vehicle among the advertisements A1 to A3 and B1 selected first and cause the specified advertisement to be displayed. Also in step S17, the processing in step S21 and S22 can be executed in a similar manner.

Note that in a case where an advertisement corresponding to the speed information of the vehicle cannot be found among the advertisements selected in step S15 or S17 as a result of the processing in step S21 and S22, the display control unit 256 may perform control to cause the advertisements selected in step S15 or S17 to be displayed. Alternatively, the display control unit 256 may perform control to stop display of an advertisement.

Further, the display control unit 256 may select an advertisement to be displayed using information on only one of the position attribute and the person attribute, and the speed information of the vehicle.

In the example in FIG. 2, the advertisements A1 to A3 generated in advance by sponsors, or the like, of the advertisements are stored in the DB 23. However, the control unit 25 may extract from the advertisement A3 of the moving image, one or more thumbnail scenes to be advertised in the advertisement A3 of the moving image and may store such scenes in the DB 23 as the advertisements A1 and A2. An arbitrary publicly known technique such as machine learning can be used as such an extraction process.

### (1C)

Another control example will be described in (1C) where the display control unit 256 changes display of the advertisement display apparatus 12 using the speed information of the vehicle.

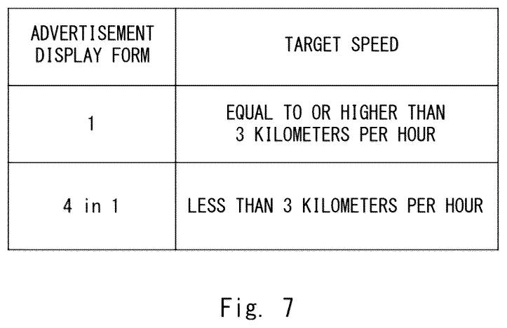

FIG. 7 is a table indicating an example of target speed corresponding to advertisement display forms, stored in the DB 23. The target speed indicates speed of the vehicle at which the advertisement is displayed in a specific display form. FIG. 7 indicates that in a case where the advertisement display form is “1”, the target speed is “equal to or higher than 3 kilometers per hour”, and in a case where the advertisement display form is “4in1”, the target speed is “less than 3 kilometers per hour”. Here, the display form of “1” indicates that one advertisement is displayed in the whole one screen of the display unit 121, and the display form of “4in1” indicates that the whole of one screen of the display unit 121 is divided into four regions, and one advertisement is displayed in each of the divided regions.

It is considered that advertising effectiveness becomes higher as the number of advertisements displayed at the vehicle at one time is larger. However, the display unit 121 is a display, and thus, a display area per one advertisement becomes smaller as the number of posted advertisements increases. Further, it is preferable to improve visibility of advertisements to be displayed as the speed of the vehicle is higher as described above. Thus, in the example related to FIG. 7, a threshold may be set for the speed to improve visibility so that the number of advertisements to be displayed at one time is increased in a case where the speed of the vehicle is low, and the number of advertisements to be displayed at one time becomes smaller as the speed of the vehicle is higher.

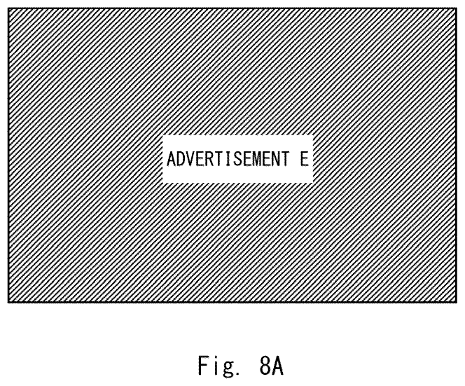

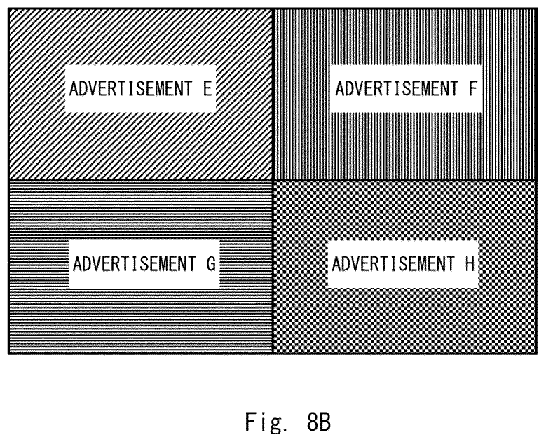

FIGS. 8A and 8B are schematic views respectively illustrating the display forms of “1” and “4in1” of the advertisements to be displayed at the display unit 121. FIG. 8A illustrates a state where an advertisement E is displayed in the whole one screen of the display unit 121, while FIG. 8B illustrates a state where advertisements E to H are respectively displayed in four regions obtained by equally dividing the screen of the display unit 121.

Note that the advertisements E to H may be, for example, advertisements of different advertisement targets or a plurality of advertisements among them may be the same advertisement or advertisement of the same advertisement target. Further, the advertisements E to H may including advertisements having the same degree of motion or advertisements having different degrees of motion. For example, the advertisement E may be an advertisement of one still image regarding an item E, and the advertisement F may be an advertisement of a moving image regarding the item E.

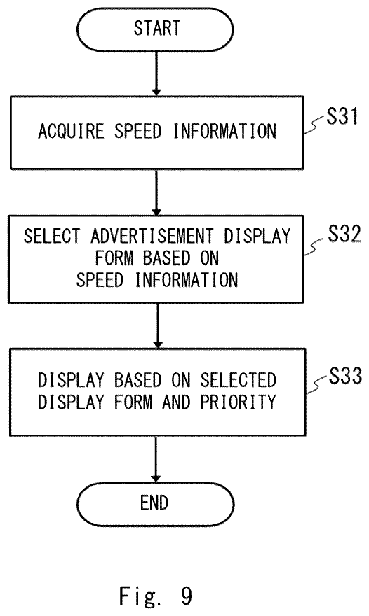

FIG. 9 is a flowchart illustrating an example of processing to be executed by the display control apparatus 20, and the processing of the display control apparatus 20 will be described below with reference to FIG. 9. First, the traveling information acquisition unit 22 acquires the speed information of the vehicle as part of the traveling information (step S31).

The display control unit 256 selects a display form of the advertisement at the advertisement display apparatus 12 using the speed information acquired in step S31 and the table indicated in FIG. 7 (step S32). Then, the display control unit 256 causes the advertisement data to be displayed at the advertisement display apparatus 12 based on the set priority of the advertisement data in accordance with the display form selected in step S32 (step S33).

As described above, the display control apparatus 20 can change the number and a size of advertisements to be displayed at the advertisement display apparatus 12 in accordance with the speed information of the vehicle. In other words, the display control apparatus 20 can improve visibility by simplifying an advertisement to be displayed in a case where the speed is high using a method different from (1B).

Note that stages of the display form are not limited to two stages, and the display form may include three or more stages. For example, a display form of “2in1” in which advertisements are displayed in two regions obtained by equally dividing one screen may be set as a display form between the display form “1” and the display form of “4in1” of the advertisement. In this case, two thresholds for the speed in FIG. 7 are provided.

The screen of the display unit 121 does not have to be equally divided. For example, in a case where the advertisements A1, C1 and D1 are displayed at the advertisement display apparatus 12 in the example indicated in FIG. 2, the display control unit 256 may set divided regions (display regions) based on the priority of the respective advertisements.

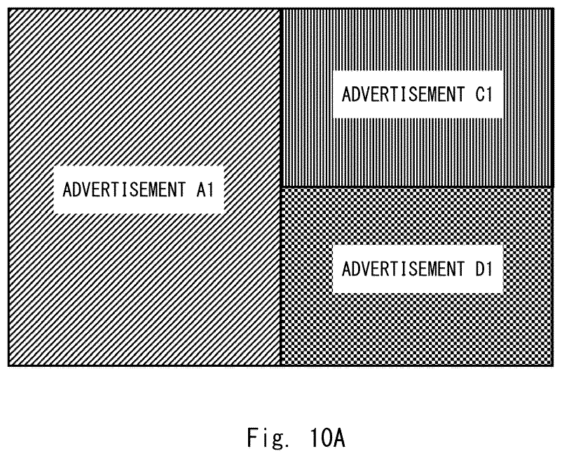

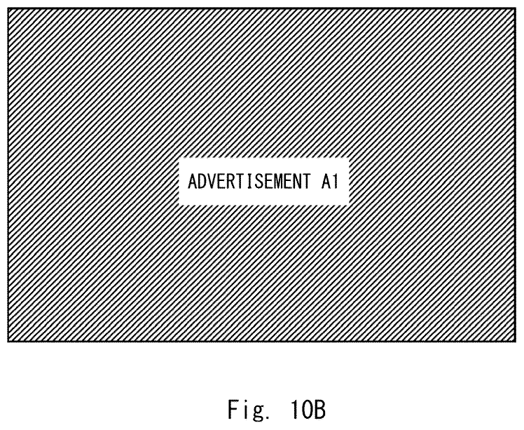

FIG. 10A is a schematic view illustrating a setting example of divided regions in the above-described case. The display control unit 256 performs control to cause the advertisement A1 to be preferentially displayed in a wide range on the display unit 121 based on a fact that the priority of the advertisement A1 is “high” and the priority of the advertisements C1 and D1 is “medium”. In FIG. 10A, the advertisement A1 is displayed in a region of a left half of the screen of the display unit 121, and each of the advertisements C1 and D1 is displayed in a region that is one fourth of the screen of the display unit 121. Note that in a case where the state changes from this state to a state where the speed of the vehicle exceeds a predetermined threshold, and the display form of the advertisement of “1” is selected in step S32, the display control unit 256 can perform control to cause only the advertisement A1 with the highest priority of “high” to be displayed at the display unit 121 as illustrated in FIG. 10B. In this manner, the display control unit 256 can perform display based on the priority of the advertisements when a plurality of advertisements are displayed.

Further, the processing in (1C) described above is combined with all or arbitrary part of the processing in (1A) and (1B). For example, in a case where the display control unit 256 selects the advertisements A1 to A3 and B1 in FIG. 2 in step S15 in (1A), the processing in step S31 and S32 in FIG. 9 may be executed at the display control apparatus 20. In a case where “4in1” is selected as the display form in step S32, the display control unit 256 determines that a plurality of advertisements among the advertisements A1 to A3 and B1 selected first can be displayed at the same time on one screen. For example, the display control unit 256 may display one type of an advertisement selected from the advertisements A1 to A3, and the advertisement B1 at the same time on one screen. In this event, display regions of the advertisements may be equal or may be determined based on the priority of the advertisements. Further, in a case where “1” is selected as the display form in step S32, the display control unit 256 determines that only one of the advertisements A1 to A3 and B1 selected first can be displayed on one screen. In this case, the display control unit 256 selects one advertisement with the highest priority among the advertisements and performs control to cause the advertisement to be displayed on one screen. Note that in a case where there are two or more advertisements with the priority of “high” in the advertisements selected first, the display control unit 256 selects an arbitrary one advertisement among the advertisements and causes the advertisement to be displayed.

Note that in a case where the processing in (1B) and the processing in (1C) are combined, thresholds for speed (for example, the thresholds indicated in FIGS. 4 and 6) for changing the degree of motion of the advertisement and thresholds for speed (for example, the thresholds indicated in FIG. 7) for changing the display form of the display unit 121 may be all different from each other, or some of the thresholds may be common.

### (1D)

In (1D), a control example will be described where the display control unit 256 changes display of the advertisement display apparatus 12 based on an attitude of a person in the captured image.

The image determination unit 254 further determines an attitude with respect to an advertisement of each person in the image using information for determining an attitude stored in the DB 23 and derives the attitude as person information. This “attitude” represents a feeling of a person with respect to the advertisement. A negative attitude indicates that the person has low interest in the advertisement or the person has a negative feeling such as a feeling of disgust with respect to the advertisement. Conversely, a positive attitude indicates that the person has high interest in the advertisement or the person has a positive feeling such as a good feeling with respect to the advertisement. The image determination unit 254 determines the attitude of the person by comparing expression and behavior of the person in the image with the information for determining an attitude. For example, the image determination unit 254 determines that the attitude is positive in a case where expression of the person in the image matches a feature amount of first expression determined in advance and determines that the attitude is negative in a case where the expression matches a feature amount of second expression determined in advance. Further, the image determination unit 254 determines whether or not the line of sight of the person is directed to the advertisement on the display unit 121 based on information on the line of sight of the person in the image, and information on a positional relationship between the display unit 121 and the imaging apparatus 11 and an angle of the imaging apparatus 11 stored in the DB 23 in advance. Through such two-stage determination, the image determination unit 254 functions as an attitude determination unit that determines an attitude of each person in the image with respect to an advertisement.

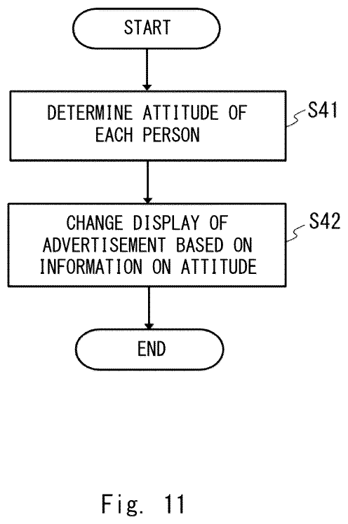

FIG. 11 is a flowchart illustrating an example of processing to be executed by the display control apparatus 20, and the processing of the display control apparatus 20 will be described below with reference to FIG. 11. First, the image determination unit 254 determines an attitude of each person in the image data with respect to an advertisement as described above (step S41). The image determination unit 254 generates information indicating an attitude of each person at each timing.

The display control unit 256 changes display of the advertisement at the advertisement display apparatus 12 using the information regarding the attitude of each person obtained in step S41 (step S42). Here, the display control unit 256 performs control to change at least one of a period during which the advertisement is displayed at the advertisement display apparatus 12 or a size of a region in which the advertisement is displayed at the advertisement display apparatus 12. The detailed processing will be described below.

For example, a case will be assumed where the display control unit 256 determines that persons of the number or a ratio equal to or more than a predetermined threshold among the persons in the image data have negative attitudes with respect to the advertisement. The predetermined threshold to be used for this determination is stored in the DB 23. In this event, the display control unit 256 acquires advertisement information of the advertisement displayed at the advertisement display apparatus 12 at a timing at which the persons have negative attitudes with respect to the advertisement with reference to the log in the DB 23 based on the determination result.

In a case where the display control unit 256 determines that the advertisement with respect to which the persons have had negative attitudes is being displayed based on the acquired advertisement information, the display control unit 256 may immediately finish the display and may display an advertisement of an advertisement target different from the advertisement target of the advertisement. Alternatively, the display control unit 256 may reduce periods or the number of times of display of the advertisement with respect to which the persons have had negative attitudes and advertisements of the same advertisement target as the advertisement target of the advertisement compared to periods or the number of times that are initially assumed. In this manner, the display control unit 256 reduces the period during which the advertisement is displayed at the advertisement display apparatus 12. Alternatively, the display control unit 256 may make a size of a region in which the advertisement with respect to which the persons have had negative attitudes is displayed at the display unit 121 smaller than an initial size.

As an opposite example, a case will be assumed where the display control unit 256 determines that persons of the number or a ratio equal to or more than a predetermined threshold among the persons in the image data have positive attitudes with respect to the advertisement. The predetermined threshold to be used in this determination is stored in the DB 23. In this event, the display control unit 256 acquires advertisement information of the advertisement that is displayed at the advertisement display apparatus 12 at a timing at which the persons have positive attitudes with respect to the advertisement with reference to the log in the DB 23 based on the determination result.

In a case where the display control unit 256 determines that the advertisement to which the persons have had positive attitudes is being displayed based on the acquired advertisement information, the display control unit 256 may repeatedly display the same advertisement once or more times even in a case where a period of the advertisement ends. The advertisement may be repeatedly displayed, for example, until the state changes to a state where it is determined that persons of the number or a ratio equal to or more than the predetermined threshold do not have positive attitudes with respect to the advertisement. Alternatively, the display control unit 256 may increase periods or the number of times of display of the advertisement with respect to which the persons have had positive attitudes and advertisements of the same advertisement target as the advertisement target of the advertisement compared to periods or the number of times that are initially assumed. In this manner, the display control unit 256 increases the period during which the advertisement is displayed at the advertisement display apparatus 12. Alternatively, the display control unit 256 may make a size of a region in which the advertisement with respect to which the persons have had positive attitudes is displayed at the display unit 121 larger than an initial size.

Note that in a case where the display control unit 256 determines that persons of the number or a ratio equal to or more than the first predetermined threshold have negative attitudes with respect to the advertisement and persons of the number or a ratio equal to or more than the second predetermined threshold have positive attitudes, the display control unit 256 may execute processing regarding one of the attitudes described above for display of the advertisement. Alternatively, the display control unit 256 may execute neither processing described above.

As described above, the display control apparatus 20 can change at least one of the period during which the advertisement is displayed at the advertisement display apparatus 12 or the size of the region in which the advertisement is displayed at the advertisement display apparatus 12 in accordance with attitudes of persons with respect to the advertisement. This can make it easier for the display control apparatus 20 to provide an advertisement that is felt appropriate by persons, so that it is possible to increase advertisement effectiveness.

The processing in (1D) described above is combined with all or arbitrary part of the processing in (1A), (1B) and (1C). For example, it is assumed that in a case where the advertisement data indicated in FIG. 2 is stored in the DB 23, the display control unit 256 causes the advertisements A3, B1, C2 and D2 to be displayed at the advertisement display apparatus 12 based on the priority in step S23 in (1B). In this event a case will be assumed where, as a result of the processing in step S41 and S42 in FIG. 11, the display control unit 256 determines that persons have negative attitudes with respect to the advertisement A3 and have positive attitudes with respect to the advertisement B1. In this case, the display control unit 256 executes at least one of control of shortening a period during which the advertisement A3 is displayed or control of making a display region of the advertisement A3 smaller than an initial region. On the other hand, the display control unit 256 executes at least one of control of lengthening a period during which the advertisement B1 is displayed or control of making a display region of the advertisement B1 larger than an initial region. The display control unit 256 may execute this control by lowering priority of the advertisement A3 stored in the DB 23 from “medium” to “low” or increasing priority of the advertisement B1 from “low” to “medium” or “high”.

As another example, a case will be assumed where, as a result of the processing in (1C), the advertisements as illustrated in FIG. 8B are displayed at the display unit 121. Here, it is assumed that as a result of the processing in step S41 and S42 in FIG. 11, the display control unit 256 determines that persons have positive attitudes with respect to the advertisement E and have negative attitudes with respect to the advertisement G. In this event, the display control unit 256 executes at least one of control of lengthening a period during which the advertisement E is displayed or control of making a display region of the advertisement E larger than an initial region or at least one of control of shortening a period during which the advertisement G is displayed or control of making a display region of the advertisement G smaller than an initial region. For example, as illustrated in FIG. 8A, the display control unit 256 may display only the advertisement E at the display unit 121. As another example, the display control unit 256 may prevent the advertisement G from being displayed and may cause the advertisement E to be displayed in a region of a left half of the display unit 121 including the region where the advertisement G is originally displayed. In this event, the advertisements F and H are displayed without change.

Note that the first embodiment described above is merely an example, and other variations can be applied. For example, types of the characteristic information are not limited to those described above. Further, while three stages are set as the degree of motion of the advertisement in (1B) and (1C), the stages of the degree of motion may be the number other than three.

The image determination unit 254 can also determine whether or not a predetermined number or a predetermined ratio or more persons of a predetermined age or older are included in the persons in the image using the information for determination stored in the DB 23 described above. In a case where the image determination unit 254 determines that the predetermined number or the predetermined ratio or more persons of the predetermined age or older are included in the image, the display control unit 256 can perform control to improve visibility of the advertisement to be displayed at the advertisement display apparatus 12.

For example, as described in (1B), in a case where the “degree of motion of the advertisement” is set at the advertisement, the display control unit 256 makes the “degree of motion of the advertisement” to be displayed equal to or lower than a predetermined degree of motion. For example, in the example of the advertisements indicated in FIG. 2, when the image determination unit 254 determines that a predetermined number or a predetermined ratio or more persons of a predetermined age or older are included in a case where the advertisement A3 having the degree of motion of “high” is being displayed at the advertisement display apparatus 12, the display control unit 256 sets the advertisement A1 or A2 as the advertisement to be displayed at the advertisement display apparatus. In this manner, the display control unit 256 can lower the degree of motion of the advertisement while keeping the same advertisement target of the advertisement to be displayed.

Further, when the image determination unit 254 makes similar determination in a case where the advertisement B1 having the degree of motion of “high” is being displayed at the advertisement display apparatus, the display control unit 256 may cause an advertisement which has the degree of motion of “medium” or “low” and for which the advertisement target is different to be displayed at the advertisement display apparatus. The advertisement to be displayed at the advertisement display apparatus may be selected based on the position attribute, the person attribute and the speed information or priority of the advertisement may be taken into account as described in (1B), and the like. As another example, the control unit 25 may extract one or more thumbnail scenes to be advertised from the advertisement B1 having the degree of motion of “high”, and the display control unit 256 may cause such scenes to be displayed as advertisements having the degree of motion of “medium” or “low”. Note that thresholds regarding the age, the number or the ratio of persons to be used in the above-described determination by the image determination unit 254 and upper limits of the “degree of motion of the advertisement” that can be displayed are stored in the DB 23 and can be used by the image determination unit 254 and the display control unit 256. Further, even in a case where a frequency of switching from an advertisement of a still image to an advertisement of another still image is applied as the “degree of motion of the advertisement”, the display control unit 256 can execute similar control.

As another example, if the image determination unit 254 determines that a predetermined number or a predetermined ratio or more persons of a predetermined age or older are included in a case where advertisements in a state of “4in1” are being displayed at the advertisement display apparatus 12 as described in (1C), the display control unit 256 performs control to change the display state to “2in1” or “1”. However, the display control unit 256 may execute control other than this if the control is control of reducing the number of advertisements to be displayed on one screen and increasing a display area per one advertisement. Further, as indicated in (1C), which advertisement is to remain to be displayed at the display unit 121 may be determined based on the priority. Thresholds regarding the age and the number or the ratio to be used in the determination are stored in the DB 23.

Humans tend to have difficulty in seeing a screen with a high degree of motion and a small object with advancing age. The image determination unit 254 can determine that there are a number of persons of a predetermined age or older by determining the image, and the display control unit 256 can improve visibility of the advertisement to be displayed in accordance with the determination result. This can achieve user-friendly advertisement display to persons of a predetermined age or older.

The display control unit 256 may change the priority of the advertisements based on frequencies of display (display periods or the number of times of display) of the advertisements, stored in the log of the DB 23. For example, in the example of the advertisements indicated in FIG. 2, the display control unit 256 may determine whether or not the display period or the number of times of display of the advertisement B1 is equal to or greater than a predetermined threshold from the data stored in the log. In a case where the display period or the number of times of display is less than the predetermined threshold, the display control unit 256 can achieve increase of the display period by raising the priority of the advertisement B1 from “low” to “medium” or “high”. Then, in a case where the display period or the number of times of display of the advertisement B1 becomes equal to or greater than the predetermined threshold as a result of the display control unit 256 making similar determination, the display control unit 256 can return the priority of the advertisement B1 to “low”.

### Second Embodiment

A second embodiment of the present disclosure will be described below with reference to the drawings. In the second embodiment, an example will be described where the speed of the vehicle is controlled in accordance with content of the advertisement to be displayed outside the vehicle.

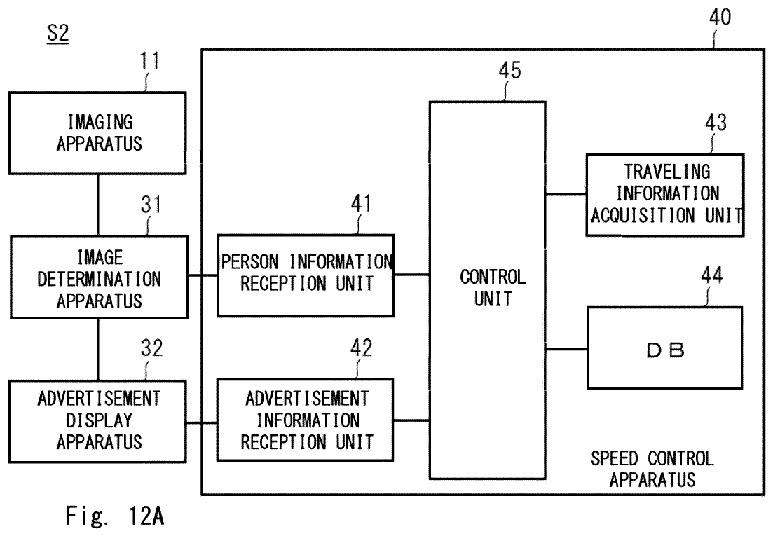

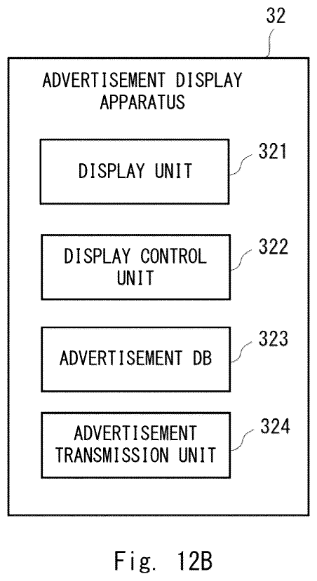

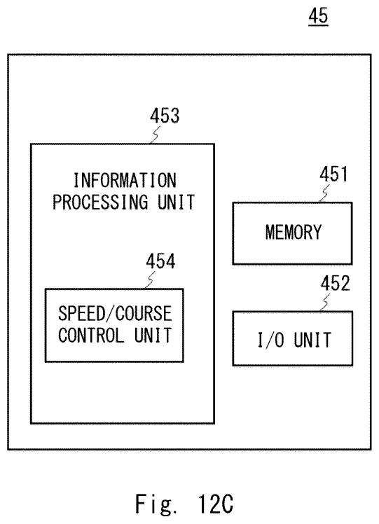

FIG. 12A is a block diagram. illustrating a schematic configuration example of a display system S2. The display system S2 includes the imaging apparatus 11, an image determination apparatus 31, an advertisement display apparatus 32 and a speed control apparatus 40. Components of the display system S2 will be described below. However, the imaging apparatus 11 is similar to that in the first embodiment, description thereof will be omitted.

The image determination apparatus 31 has functions similar to the functions of the image determination unit 254 according to the first embodiment and derives person information in the image data captured by the imaging apparatus 11 using information for determination stored in a storage unit (not illustrated). Details of the person information to be derived are as described in the first embodiment.

The advertisement display apparatus 32 is a digital signage capable of switching an advertisement to be displayed by control by the advertisement display apparatus 32. For example, the advertisement to be displayed is changed in accordance with the person information or a situation regarding the vehicle such as position information of the vehicle.

FIG. 12B is a block diagram illustrating a configuration example of the advertisement display apparatus 32. As illustrated in FIG. 12B, the advertisement display apparatus 32 includes a display unit 321, a display control unit 322, an advertisement DB 323 and an advertisement transmission unit 324. The respective units will be described below.

The display unit 321, which is a medium that displays the advertisement data selected by the display control unit 322 so as to be able to be viewed by persons, includes a display in a similar manner to the display unit 121.

The display control unit 322 selects appropriate advertisement data from the advertisement data stored in the advertisement DB 323 and causes the advertisement data to be displayed at the advertisement display apparatus 12. The display control unit 322 selects an advertisement to be displayed at the display unit 321 using at least one of parameters such as the person information in the image, a position attribute of a current position of the vehicle, speed information of the vehicle and priority of the advertisements and causes the advertisement to be displayed at the display unit 321. Details of this are as described in (1A) to (1D) in the first embodiment, and thus, description will be omitted. Further, the display control unit 322 stores the advertisement information determined to be displayed at the display unit 321 and display time of the advertisement information in the advertisement DB 323 as a log.

The advertisement DB 323 is a DB that stores advertisement data that can be displayed at the advertisement display apparatus 32. Specifically, the advertisement DB 323 is a recording medium such as a flash memory, a memory card and a hard disk drive (HDD). Further, the advertisement DB 323 may be provided outside the advertisement display apparatus 32, in which case, the advertisement display apparatus 32 may acquire the data stored in the advertisement DB 323 by connecting to the advertisement DB 323 via an information transmission/reception unit (not illustrated). In the advertisement DB 323, characteristic information of the advertisements is stored in association with the advertisement data. The specific example is as described in the first embodiment. Further, in the advertisement DB 323, the advertisement information that the display control unit 322 controls to display at the advertisement display apparatus 32 and information on display time of the advertisement information are stored as a log.

The advertisement transmission unit 324 is a hardware interface that transmits advertisement information of the advertisement selected by the display control unit 322. The advertisement information is a label indicating the advertisement displayed at the advertisement display apparatus 32 and characteristic information of the advertisement, and the specific example is as described in the first embodiment. The advertisement information transmitted by the advertisement transmission unit 324 is output to the speed control apparatus 40.

Description will be continued returning to FIG. 12A. The speed control apparatus 40, which controls automated driving of the vehicle, controls at least one of the speed of the vehicle or a course by acquiring the person information, the traveling information and the information on the advertisement to be displayed. The speed control apparatus 40 includes a person information reception unit 41, an advertisement information reception unit 42, a traveling information acquisition unit 43, a DB 44 and a control unit 45. The respective units will be described in detail below.

The person information reception unit 41 is a hardware interface that receives the person information transmitted from the image determination apparatus 31. The person information reception unit 41 outputs the received person information to the control unit 45.

The advertisement information reception unit 42 is a hardware interface that receives the advertisement information transmitted from the advertisement transmission unit 324 of the advertisement display apparatus 32. The advertisement information reception unit 42 outputs the received advertisement information to the control unit 45.

The traveling information acquisition unit 43 acquires the position information and the speed information of the vehicle as the traveling information of the vehicle in a similar manner to the traveling information acquisition unit 22 according to the first embodiment. Note that the traveling information of the vehicle may include detailed information on a road configuration around the vehicle (for example, information on roads on which the vehicle can travel and areas where the vehicle can be stopped around the vehicle).

In the DB 44, map information necessary for determining a position attribute of a current position of the vehicle, and information on a travel route of the vehicle are stored. Specifically, the DB 44 is a recording medium such as a flash memory, a memory card and a hard disk drive (HDD). Further, the DB 44 may be provided outside the speed control apparatus 40, in which case, the speed control apparatus 40 may acquire the data stored in the DB 44 by connecting to the DB 44 via an information transmission/reception unit (not illustrated). In the DB 44, a table indicating a relationship between degrees of motion of the advertisements or display forms and target speed is stored in addition to the above information. Further, in the DB 44, various kinds of thresholds, and the like, to be used for various kinds of determination processing are stored.

The control unit 45 sets at least one of the speed or the course of the vehicle using at least one of the advertisement information, the person information or the traveling information acquired by the speed control apparatus 40. Then, the control unit 45 controls an engine and orientation of tires of the vehicle so that the vehicle travels based on the set speed and course.

FIG. 12C is a block diagram of the control unit 45. The control unit 45 includes a memory 451, an I/O unit 452 and an information processing unit 453. The memory 451 and the I/O unit 452 are similar to the memory 251 and the I/O unit 252 according to the first embodiment, and thus, description will be omitted.

The information processing unit 453 is constituted with an arbitrary processor, and the like, in a similar manner to the information processing unit 253 according to the first embodiment. The information processing unit 453 implements functions of a speed/course control unit 454, and the like, by reading out software (computer program) from the memory 451 and executing the software. The functions of the speed/course control unit 454 will be described below.

The speed/course control unit 454 determines the speed and the course of the vehicle based on the traveling information and the travel route of the vehicle stored in the DB 44. However, the speed/course control unit 454 can determine the speed and the course of the vehicle further using the advertisement information received by the advertisement information reception unit 42.

For example, in the DB 44, a table indicating a relationship between degrees of motion of the advertisements and target speed as indicated in FIG. 4 may be stored. The speed/course control unit 454 determines which of “low”, “medium” and “high”, a degree of motion of the advertisement that is currently displayed is, based on the advertisement information. If the degree of motion of the advertisement is “low”, there is no restriction on the speed, and thus, the speed/course control unit 454 determines the speed and the course of the vehicle based on the traveling information and the travel route. However, if the degree of motion of the advertisement is “medium” or “high”, as indicated in FIG. 4, there is speed restriction of “less than 7 kilometers per hour” or “less than 3 kilometers per hour”. In this case, the speed/course control unit 454 sets the speed based on the traveling information and the travel route so as to satisfy a condition of this speed restriction.

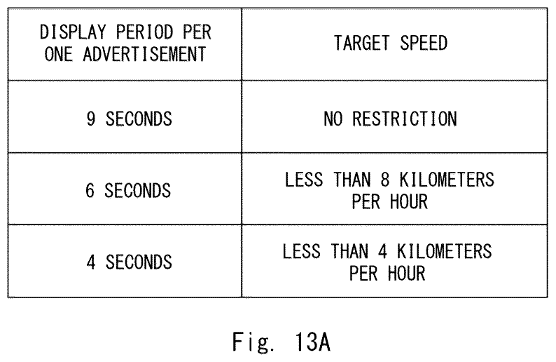

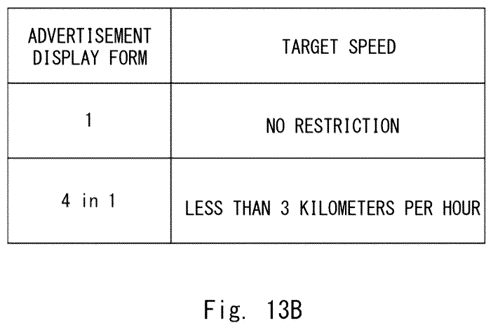

FIG. 13A indicates another example of a table stored in the DB 44 and indicates target speed corresponding to a display period per one still image of the advertisement. The speed/course control unit 454 determines which of “4 seconds”, “6 seconds” and “9 seconds”, a display period per one still image of the advertisement that is currently displayed is, based on the advertisement information. If the display period is “9 seconds”, the speed/course control unit 454 determines the speed and the course of the vehicle based on the traveling information and the travel route. However, if the display period is “4 seconds” or “6 seconds”, the speed/course control unit 454 determines the speed and the course of the vehicle based on the traveling information and the travel route so as to satisfy speed restriction of “less than 8 kilometers per hour” or “less than 4 kilometers per hour”.

FIG. 13B illustrates another example of a table stored in the DB 44 and indicates target speed corresponding to a display form of the advertisement. The speed/course control unit 454 determines which of “1” and “4in1”, a display form of the advertisement that is currently displayed is, based on the advertisement information. If the display period is “1”, the speed/course control unit 454 determines the speed and the course of the vehicle based on the traveling information and the travel route. However, if the display period is “4in1”, the speed/course control unit 454 determines the speed and the course of the vehicle based on the traveling information and the travel route so as to satisfy speed restriction of “less than 3 kilometers per hour”.

Further, the speed/course control unit 454 may determine the speed and the course of the vehicle further using the person information. For example, the speed/course control unit 454 may determine whether there are many persons at a location away from the vehicle by equal to or longer than a predetermined distance based on the person information output by the image determination apparatus 31. A state where “there are many persons” may be, for example, a state where there are a predetermined number or more persons or a state where there are more persons than persons at a location away from the vehicle by less than the predetermined distance. The thresholds or rules for determination described above are stored in the DB 44.

Note that in the above-described example, the speed/course control unit 454 may set the course so as to further satisfy a condition of speed restriction. For example, the speed/course control unit 454 may set the speed and course again so as to stop the vehicle in an area based on information on the areas where the vehicle can be stopped, included in the traveling information.

In a case where there are many persons at a location away from the vehicle by equal to or longer than the predetermined distance, the speed/course control unit 454 determines whether or not the vehicle can further approach the location away from the vehicle, from the current vehicle position based on the information on roads on which the vehicle can travel around the vehicle, included in the traveling information. In a case where the vehicle can approach the location, the speed/course control unit 454 determines the speed and the course of the vehicle so that the vehicle approaches the location. Note that in a case where the speed/course control unit 454 determines that there is an area where the vehicle can be stopped around the location away from the vehicle, based on the information on an area where the vehicle can be stopped, the speed/course control unit 454 may determine the speed and the course of the vehicle so as to stop the vehicle in the area. Further, the speed/course control unit 454 may determine the speed and the course of the vehicle so that the vehicle faces in such a direction that enables persons at the location away from the vehicle to visually confirm the display unit 321. Note that in a case where the vehicle cannot approach the location, the speed/course control unit 454 may perform control to stop the vehicle at the current position of the vehicle or in an area where the vehicle can be stopped around the current position so that the vehicle does not get away from the location where there are many persons.

As another example, the speed/course control unit 454 acquires a person attribute of the advertisement displayed at the advertisement display apparatus 32 as the advertisement information. Then, the speed/course control unit 454 may divide an area around the vehicle into a plurality of areas based on the person information output by the image determination apparatus 31 and may determine an area including the largest number of persons having a person attribute that matches the person attribute of the advertisement with reference to person attributes of persons in the respective areas. The speed/course control unit 454 then determines whether or not an area including the largest number of persons is away from the vehicle by equal to or longer than a predetermined distance, and in a case where the area is away from the vehicle, executes processing of determining whether or not the vehicle can approach the area, or the like, as described above and performs control so that the vehicle approaches the area including the largest number of persons to reliably show the advertisement.

As a still another example, the speed/course control unit 454 may determine whether or not there is a minor in the image based on the person information output by the image determination apparatus 31 in a case where the advertisement displayed at the advertisement display apparatus 32 is the advertisement D1 (that is, the advertisement “for adults”) indicated in FIG. 2. In a case where the image includes at least one minor, the speed/course control unit 454 can determine the speed and the course of the vehicle so that the vehicle gets away from the minor or the vehicle faces in such a direction that makes the display unit 321 out of sight of the minor.

Further, the speed/course control unit 454 may determine the speed and the course of the vehicle based on information on attitudes of persons derived as the person information by the image determination apparatus 31. Details of the attitudes of the persons are as described in (1D).

For example, the speed/course control unit 454 may determine whether or not persons of the number or a ratio equal to or more than a predetermined threshold in the image have negative attitudes with respect to the advertisement based on the person information. In a case where it is determined that persons of the number or a ratio equal to or more than the predetermined threshold have negative attitudes, the speed/course control unit 454 can determine the speed and the course of the vehicle so that the vehicle gets away from the persons having negative attitudes or the vehicle faces in such a direction that makes the display unit 321 out of sight of the persons.

Conversely, the speed/course control unit 454 may determine whether or not persons of the number or a ratio equal to or more than a predetermined threshold in the image have positive attitudes with respect to the advertisement based on the person information. In a case where it is determined that persons of the number or a ratio equal to or more than the predetermined threshold have positive attitudes, the speed/course control unit 454 executes processing of determining whether or not the vehicle can approach the persons, or the like, as described above, and performs control so that the vehicle approaches the persons as close as possible to reliably show the advertisement. Details thereof are as described above.

In addition, various variations described in the first embodiment can be applied to the processing described above in the second embodiment.

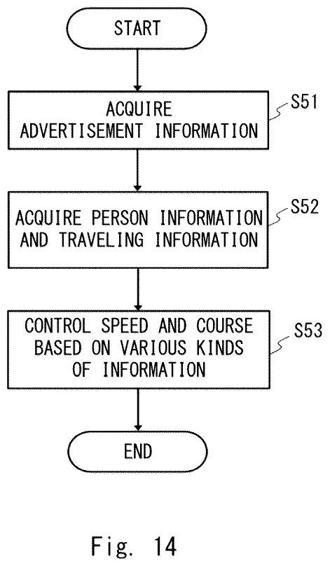

FIG. 14 is a flowchart illustrating an example of processing to be executed by the speed control apparatus 40, and the processing of the speed control apparatus 40 will be described below with reference to FIG. 14. First, the advertisement information reception unit 42 receives the advertisement information from the advertisement display apparatus 32 (step S51). Further, the person information reception unit 41 and the traveling information acquisition unit 43 respectively acquire the person information and the traveling information (step S52).

Then, the speed/course control unit 454 controls the speed and the course of the vehicle using various kinds of information acquired in step S51 and S52 (step S53). Details thereof are as described above. As described above, in a case where the degree of motion of

the advertisement that is displayed is high or a display region per one advertisement is small due to a large number of advertisements that are displayed, the speed control apparatus 40 can decrease the speed of the vehicle or stop the vehicle. It is therefore possible to improve visibility of the advertisement by controlling the speed in accordance with a situation where the advertisement is displayed.

Further, the speed control apparatus 40 can perform control so that the vehicle approaches persons who have interest in the advertisement or persons having a person attribute targeted by the advertisement based on the person information (for example, information on attitudes of the persons) around the vehicle. On the other hand, the speed control apparatus 40 can control movement of the vehicle so that the vehicle gets away from persons having negative attitudes with respect to the advertisement or so as not to show the advertisement. In this manner, the speed control apparatus 40 can prevent persons from having negative impressions with respect to the advertisement as well as effectively show the advertisement.

Note that the present disclosure is not limited to the above-described embodiments and can be changed as appropriate within a range not deviating from the gist. For example, all or arbitrary part of various kinds of information stored in the DB 23 in the first embodiment may be stored in cloud instead of being stored in the DB 23. The display control unit 256 can acquire desired information by accessing the DB 23 through a network as necessary. For example, in a case where advertisement data is stored in cloud, the display control unit 256 accesses the DB 23 through a network and then selects appropriate advertisement data to be displayed at the advertisement display apparatus 12 from the DB 23 in a similar manner to the processing described in the first embodiment based on the traveling information and information on attributes of persons in the image data and an environment around the vehicle. Then, the display control unit 256 acquires the selected advertisement data from the DB 23 and outputs the advertisement data to cause the advertisement data to be displayed at the advertisement display apparatus 12.

Further, also in the second embodiment, the advertisement DB 323 may be stored in cloud instead of being provided within the advertisement display apparatus 32. The advertisement transmission unit 324 transmits the advertisement information that is acquired from the DB 23 so as to be displayed at the advertisement display apparatus 32, to the speed control apparatus 40. The speed control apparatus 40 executes the processing described in the second embodiment based on the advertisement information.

As the display unit of the advertisement display apparatus, an electric bulletin board using a light emitting element may be used instead of a display. In this case, speed of switching of characters or pictures of an advertisement on the electric bulletin board and a degree of blinking of characters or pictures on the electric bulletin board correspond to the degree of change of the image of the advertisement described above. The speed of switching of the characters or the pictures of the advertisement on the electric bulletin board may be expressed as a period required for the image transitions from a certain still image to another still image or may be expressed as scrolling speed of the characters or the pictures. As an example, while characters of the advertisement on the electric bulletin board are displayed while being scrolled at high speed in a case where the vehicle is stopped, the same characters of the advertisement on the electric bulletin board are displayed while being scrolled at low speed or not scrolled in a case where the vehicle is traveling at speed equal to or higher than certain speed.

As another example of the display unit of the advertisement display apparatus, a projection unit that projects an advertisement on a projection area such as a wall using light, such as projection mapping may be used. In a case where the projection unit is used as the display unit, the imaging apparatus of the vehicle is preferably mounted on the vehicle at such a position and an angle that can image persons who visually confirm the projection unit. Further, a speech output unit that outputs speech related to the advertisement, such as a speaker, may be provided on the vehicle for advertisement in addition to the advertisement display unit.

The imaging apparatus 11 described in the embodiments does not have to be mounted on the vehicle. For example, the advertisement display apparatus or the speed control apparatus may execute the above-described control using image data captured by a camera that images surroundings at a current location of the vehicle or at a location of a destination. The camera may be, for example, a fixed monitoring camera or may be a movable camera mounted on a drone, or the like.

Further, the display control apparatus 20 and the speed control apparatus 40 described in the embodiments do not have to be provided in the vehicle and may be provided outside the vehicle. The display control apparatus 20 and the speed control apparatus can communicate with other apparatuses in the system through wireless communication as well as wired communication.

The advertisements of the present disclosure are not limited to advertisements of commercial items, services and companies and naturally include public service advertisements and advertisements provided by administrative bodies.

A target on which the advertisement display apparatus of the present disclosure is mounted is not limited to an automobile and can be all mobile objects that can move with its own force or by receiving external force. For example, the mobile objects may be vehicles other than an automobile, railroad vehicles, airplanes, drones, or the like. Further, the mobile objects may be manned objects or unmanned objects.

As described above, one or more processors provided in the apparatus such as the display control apparatus, the advertisement display apparatus and the speed control apparatus in the above-described embodiments execute one or more programs including commands for causing a computer to perform algorithm described using the drawings. The processing described in the embodiments can be implemented through this processing.

A (The) program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been described above with reference to the embodiments, the present disclosure is not limited to the above. The configuration of the present disclosure incorporates substantially the same configurations that can be assumed by the person skilled in the art, and various changes that can be understood can be made.

According to the present embodiment, it is possible to provide a display control apparatus, a speed control apparatus, a display control method, and a program capable of improving visibility of an advertisement in accordance with a situation.

Part or all of the above-described embodiments can be described as the following supplementary notes, but not limited to the following.

### Supplementary Note 1

A display control apparatus including:
a speed information acquisition unit configured to acquire speed information of a mobile object provided with an advertisement display unit; and
a display control unit configured to execute processing of changing a degree of change of an image of an advertisement to be displayed at the advertisement display unit based on the speed information.

### Supplementary Note 2

The display control apparatus according to supplementary note 1, in which the display control unit displays an advertisement of a still image at the advertisement display unit as the advertisement and changes a period during which the advertisement of the still image is displayed based on the speed information.

### Supplementary Note 3

The display control apparatus according to supplementary note 1 or 2, further including a person attribute determination unit configured to determine an attribute of a person in image data obtained by imaging surroundings of the mobile object,
in which the display control unit executes processing of changing the degree of change of the image of the advertisement to be displayed at the advertisement display unit based on the speed information and the attribute of the person.

### Supplementary Note 4

A speed control apparatus including:
an advertisement information acquisition unit configured to acquire advertisement information to be displayed at an advertisement display unit provided on a mobile object; and
a control unit configured to control speed of the mobile object based on the advertisement information.

### Supplementary Note 5

A display control method including:
a speed information acquisition step of acquiring speed information of a mobile object provided with an advertisement display unit; and
a display control step of executing processing of changing a degree of change of an image of an advertisement to be displayed at the advertisement display unit based on the speed information.

### Supplementary Note 6

The display control apparatus according to any one of supplementary notes 1 to 3, further including:
an attitude determination unit configured to determine an attitude of a person in image data obtained by imaging surroundings of the mobile object with respect to the advertisement displayed at the advertisement display unit,
in which the display control unit changes a period during which the advertisement is displayed at the advertisement display unit based on information on the attitude.

### Supplementary Note 7

The speed control apparatus according to supplementary note 4, in which the control unit controls at least one of speed or a course of the mobile object based on the advertisement information and information on a person in image data obtained by imaging surroundings of the mobile object.

### Supplementary Note 8

The speed control apparatus according to supplementary note 7, in which the information on the person includes information on an attitude of the person in the image data with respect to the advertisement information displayed at the advertisement display unit.

### Supplementary Note 9

A program for causing a computer to execute:
a speed information acquisition step of acquiring speed information of a mobile object provided with an advertisement display unit; and
a display control step of executing processing of changing a degree of change of an image of an advertisement to be displayed at the advertisement display unit based on the speed information.

### Supplementary Note 10

A speed control method including:
an advertisement information acquisition step of acquiring advertisement information to be displayed at an advertisement display unit provided on a mobile object; and
a control step of controlling speed of the mobile object based on the advertisement information.

### Supplementary Note 11

A program for causing a computer to execute:
an advertisement information acquisition step of acquiring advertisement information to be displayed at an advertisement display unit provided on a mobile object; and
a control step of controlling speed of the mobile object based on the advertisement information.

The first and second embodiments can be combined in whole or in part as desirable by one of ordinary skill in the art.

While the present disclosure has been described in terms of several embodiments, those skilled in the art will recognize that the present disclosure can be practiced with various modifications within the spirit and scope of the appended claims and the present disclosure is not limited to the examples described above.

Further, the scope of the claims is not limited by the embodiments described above.

Furthermore, it is noted that, Applicant's intent is to

encompass equivalents of all claim elements, even if amended later during prosecution.

What is claimed is:

1. A speed control apparatus including:
an advertisement information acquisition unit configured to acquire advertisement information to be displayed at an advertisement display unit provided on a mobile object; and
a control unit configured to control speed of the mobile object based on the advertisement information.

2. The speed control apparatus according to claim 1, in which the control unit controls at least one of speed or a course of the mobile object based on the advertisement information and information on a person in image data obtained by imaging surroundings of the mobile object.

3. The speed control apparatus according to claim 2, in which the information on the person includes information on an attitude of the person in the image data with respect to the advertisement information displayed at the advertisement display unit.

4. A speed control method including:
an advertisement information acquisition step of acquiring advertisement information to be displayed at an advertisement display unit provided on a mobile object; and
a control step of controlling speed of the mobile object based on the advertisement information.

5. A non-transitory computer readable medium having a program stored therein, the program causing a computer to execute:
an advertisement information acquisition step of acquiring advertisement information to be displayed at an advertisement display unit provided on a mobile object; and
a control step of controlling speed of the mobile object based on the advertisement information.
